(19) United States
(12) Patent Application Publication
(10) Pub. No.: US 2013/0341335 A1
(43) Pub. Date: Dec. 26, 2013

(54) NESTABLE BAKEWARE SYSTEM

(71) Applicant: WKI HOLDING COMPANY, INC., Rosemont, IL (US)

(72) Inventors: Arif SITABKHAN, Chicago, IL (US); John CHAP, Woodridge, IL (US); Dan CUTCHIN, Chicago, IL (US); Klara PITHYOU, Chicago, IL (US); Reggy HUDGINS, Grayslake, IL (US); Demetrius ROMANOS, Cincinnati, OH (US); Bryan SHOVA, Milford, OH (US); Kory GUNNERSON, Cincinnati, OH (US); Kieron TSE, Mount Prospect, IL (US)

(73) Assignee: WKI HOLDING COMPANY, INC., Rosemont, IL (US)

(21) Appl. No.: 13/782,774

(22) Filed: Mar. 1, 2013

Related U.S. Application Data
(60) Provisional application No. 61/664,515, filed on Jun. 26, 2012.

(51) Int. Cl. A47J 27/00

(52) U.S. Cl. CPC A47J 27/002
USPC 220/573.5; 29/428

(57) ABSTRACT

A nestable bakeware system includes a first bakeware container having a first container outer rim and defining a first recess, and a second bakeware container disposed within the first recess. A third bakeware container is disposed within the first recess and resides adjacent to the second bakeware container. The second and third bakeware containers are smaller than the first bakeware container and differ from one another. A lid bakeware container has a lid container outer rim and defines a second recess. The lid container outer rim is positionable in mating engagement with the first container outer rim to enclose the second bakeware container and the third bakeware container within a cavity defined by the first recess and the second recess.

### CROSS-REFERENCE TO RELATED APPLICATION

This application claims the benefit of and priority to U.S. Provisional Patent Application No. 61/664,515, filed Jun. 26, 2012, the entire contents of which are hereby incorporated by reference.

### TECHNICAL FIELD

The present invention relates generally to bakeware and more particularly to nestable bakeware that can be stored in a minimal amount of space.

### BACKGROUND

Bakeware is known having a variety of shapes and sizes for cooking and baking different food items. In many cases, certain types of bakeware are configured to nest together with in order to reduce the storage space required to store two or more bakeware items. For example, cookie sheets, muffin tins, meatloaf pans, and the like can all be configured such that two or more items can be nested together. One shortcoming of these known products is that they are configured only to nest with identically configured items—that is, cookie sheets only nest with identically configured cookie sheets, and muffin tins only nest with identically configured muffin tins. In many cases, consumers do not require more than one of a certain bakeware item. In such instances, the fact that the bakeware item can nest with another identically configured bakeware item is of no benefit to the consumer.

### SUMMARY

The present disclosures generally relate to nestable bakeware. In particular, nestable bakeware is provided in which several pieces of differently configured bakeware are adapted to nest closely with one another.

Accordingly, in some aspects, a nestable bakeware system includes a first bakeware container having a first recess, the first recess being defined by a first width and a first length. A second bakeware container is disposed within the first recess and is defined by a second width and a second length. The second width is less than or equal to the first width, and the second length is smaller than the first length. A third bakeware container is disposed within the first recess generally in an adjacent relationship to the second bakeware container. The third bakeware container is defined by a third width and a third length. The third width is less than the first width, and the third length is less than the first length and less than or equal to the second length.

In other aspects, a method of packaging a plurality of differently shaped bakeware items is provided and includes disposing a second bakeware container in a recess defined by a first bakeware container. The recess has a first width and a first length, and the second bakeware container has a second width smaller than the first width and a second length smaller than the first length. The method also includes disposing a third bakeware container in the recess adjacent to the second bakeware container. The third bakeware container has a third width that is less than the second width, and the second bakeware container and the third bakeware container substantially completely occupy the recess defined by the first bakeware container.

In still other aspects, a nestable bakeware system includes a first bakeware container defining a first recess and having a first container outer rim and a first container bottom wall. The first container outer rim includes a first container perimeter. A substantially square second bakeware container is disposed within the first recess and includes a second container outer rim, a second container bottom wall, and a side length. The second container outer rim includes a second container perimeter. A third bakeware container is disposed within the first recess and resides adjacent to the second bakeware container. The third bakeware container includes a third container outer rim, a third container bottom wall, and a third container width. The third container outer rim includes a third container perimeter. A fourth bakeware container has a plurality of downwardly extending cups. A first plurality of the cups are received within the second bakeware container, and a second plurality of the cups are received within the third bakeware container. The fourth bakeware container also includes a fourth container outer rim having a fourth container perimeter. A fifth bakeware container has a fifth container outer rim and defines a second recess. The fifth container outer rim is positionable in mating engagement to enclose the second bakeware container, the third bakeware container, and the fourth bakeware container within a cavity defined by the first recess and the second recess. A securement secures the first container outer rim and the fifth container outer rim to one another. The third container width is less than the side length of the second bakeware container. When the second bakeware container and the third bakeware container are disposed within the first recess, the second container outer rim and the third container outer rim rest upon the first container outer rim, the second container perimeter and the third container perimeter are both inwardly offset with respect to the first container perimeter, and the second container bottom wall and the third container bottom wall are spaced above the first container bottom wall. The fourth container perimeter is inwardly offset with respect to the second container perimeter and third container perimeter when the cups of the fourth bakeware container are received within the second bakeware container and the third bakeware container. A combined height of the fourth container outer rim resting upon the second container outer rim and the third container outer rim is less than a depth of the fifth bakeware container.

Features, advantages and embodiments of the nestable bakeware system may be set forth, or are apparent, from consideration of the following description. Moreover, it is to be understood that the following description is exemplary and intended to provide further explanation without limiting the scope of the invention.

### BRIEF DESCRIPTION OF THE DRAWINGS

To understand the present disclosure, it will now be described by way of example, with reference to the accompanying drawings in which embodiments of the disclosures are illustrated and, together with the descriptions below, serve to explain the principles of the disclosure.

FIG. 1 is a perspective view of a nestable bakeware system according to one embodiment.

FIG. 2 is an exploded perspective view of the nestable bakeware system of FIG. 1.

FIG. 3 is a section view taken along line 3-3 of FIG. 1.

The components in the drawings are not necessarily to scale, emphasis instead being placed upon clearly illustrating the principles of the present disclosure.

### DETAILED DESCRIPTION

While the nestable bakeware system discussed herein is susceptible of embodiments in many different forms, there is shown in the drawings, and will herein be described in detail, exemplary embodiments with the understanding that the present description is to be considered as an exemplification of the principles of the masking system and is not intended to limit the subject matter of the system to the embodiments illustrated.

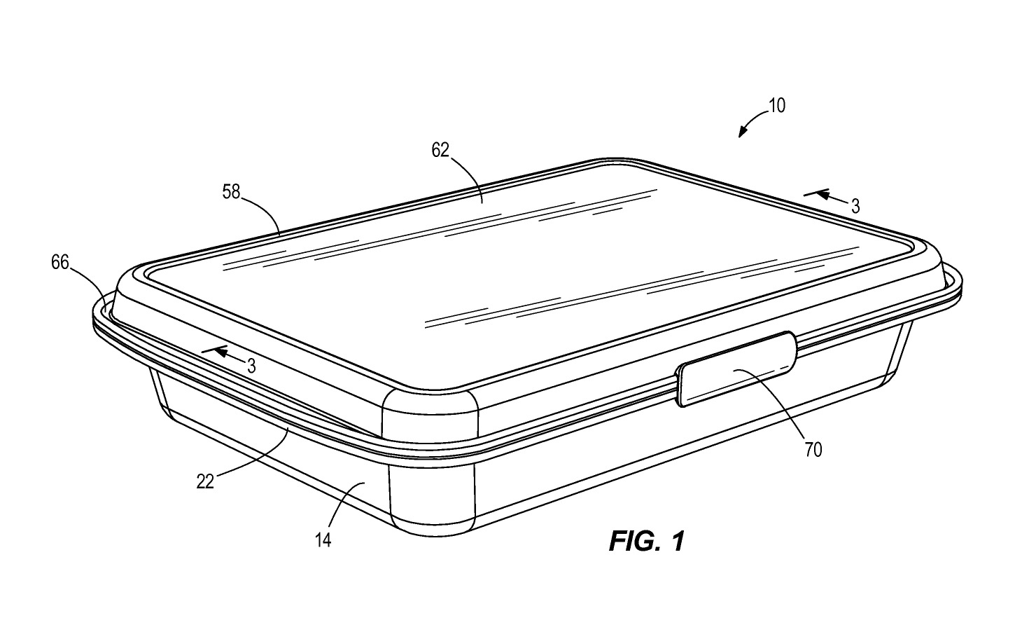

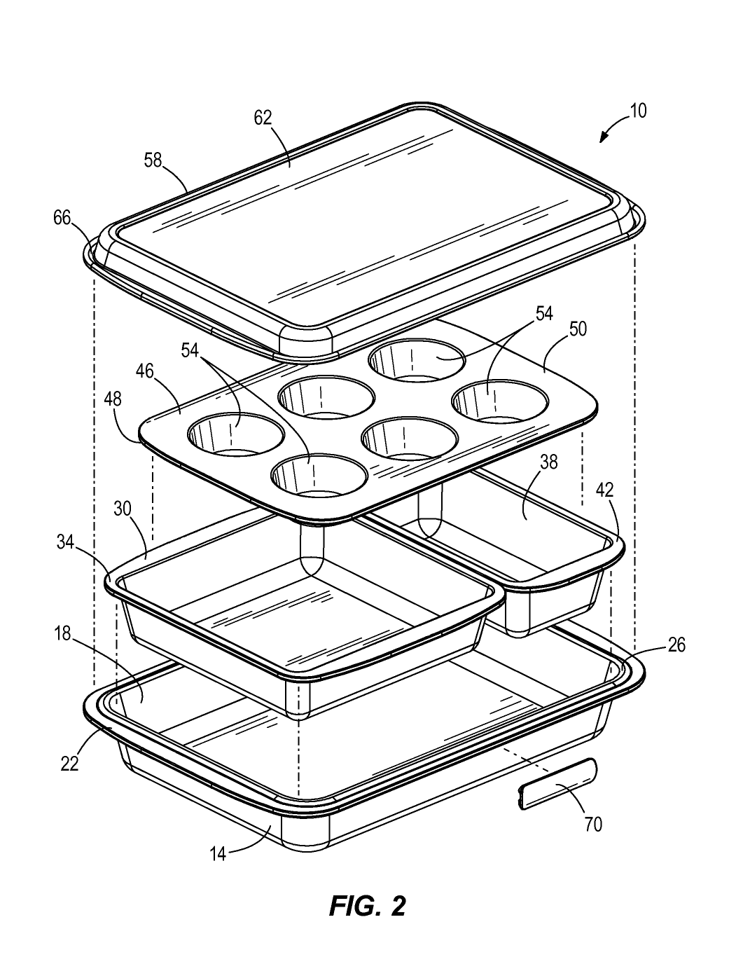

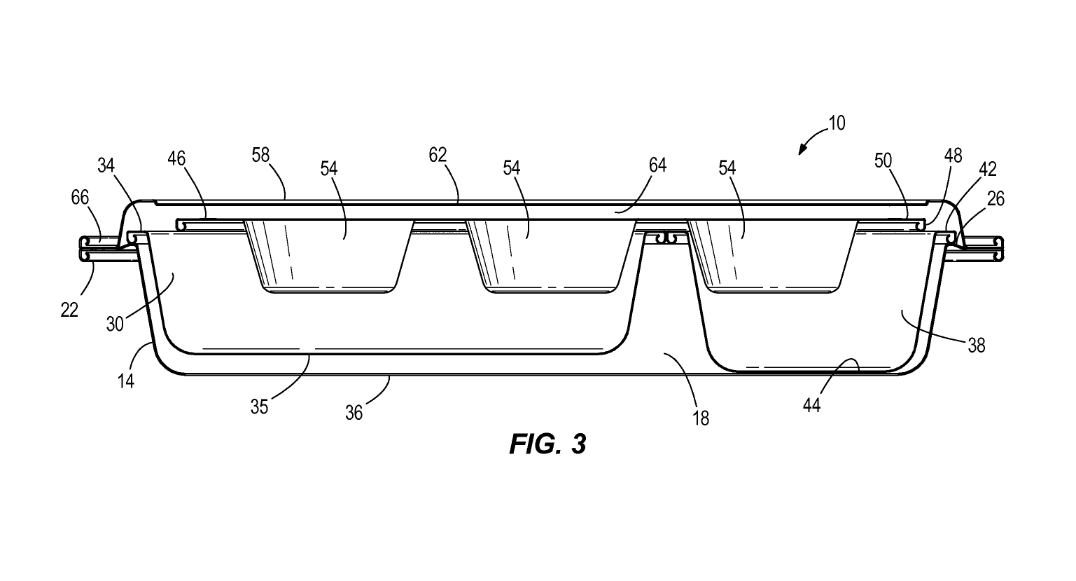

FIGS. 1-3 illustrate a nestable bakeware system 10 that allows several pieces of differently-configured bakeware containers to be stored in a relatively small amount of space. In one exemplary embodiment, at least three dissimilar bakeware items are provided in which two of the three items nest within one of the other items. The illustrated system 10 includes a generally rectangular and relatively deep first pan 14. The first pan 14 is generally the largest pan of the system 10 and defines a first recess or first recessed area 18 that is surrounded by an outer rim 22. The outer rim 22 may be substantially flat, or may include a raised ridge 26 as shown in FIGS. 2 and 3. In some embodiments the first pan 14 is a substantially rectangular cake pan such that the first recessed area 18 has a first length, a first width, and a first depth. Exemplary embodiments of the first pan 14 may include a first length of about 18 inches, a first width of about 12 inches, and a first depth of about 4 inches. Of course the specific length, width, and depth of the first pan 14 may vary. For example the length and width may vary by plus or minus 6 inches, and the depth may vary by plus or minus 2 inches.

The system 10 also includes a second pan 30 that may be disposed or nested within the recessed area 18 of the first pan 14. In the illustrated embodiment the second pan 30 is substantially square and can nest within the first pan 14. For example, the second pan 30 may include an outer rim 34 that rests upon the outer rim 22 of the first pan 14 when the second pan 30 is positioned in the recessed area 18. As shown in FIG. 3, the perimeter of the outer rim 34 of the second pan 30 is inwardly offset with respect to the outer rim 22 of the first pan 14 when the second pan 30 is positioned in the recessed area 18. For embodiments of the first pan 14 having the raised ridge 26, the outer rim 34 of the second pan 30 rests upon the raised ridge 26. The second pan 30 is configured such that when the outer rim 34 rests upon the ridge 26, a bottom wall 35 of the second pan 30 is spaced above a bottom wall 36 of the first pan 14. The second pan 30 may have second pan side dimensions, including a second pan length and a second pan width. In the illustrated construction in which the second pan 30 is a square pan, the second pan side dimensions are equal to one another. In some configurations, the second pan length may be substantially equal to the first width. In this regard, when the second pan 30 is nested within the first pan 14, the second pan extends substantially completely across the first pan 14 in the first width direction. When not configured as a square pan the second pan 30 may have a second pan length that is substantially equal to the first width, and a second pan width that is less than the second pan length dimension. Alternatively, the second pan 30 may have a second pan width that is substantially equal to the first width, and a second pan length that is less than the second length.

The system 10 may also include a third pan 38 that may be disposed or nested within the recessed area 18 of the first pan 14. In some embodiments the third pan 38 may also be capable of being disposed or nested within the recessed area of the second pan 30. In the illustrated configuration, the third pan 38 is substantially rectangular and may be disposed within the recessed area 18 of the first pan 14 substantially adjacent the second pan 30. The third pan 38 may have a third pan length that is substantially equal to the second pan side dimensions. The third pan 38 may also have a third pan width such that a sum of the third pan width and the second pan side dimension (when the second pan 30 is a square pan) or the second pan width dimension (when the second pan 30 is a rectangular pan) is substantially equal to the first length, as shown for example in FIG. 3. In some configurations, the third pan 38 may be what is known in the art as a loaf pan. In other configurations, the third pan 38 may be substantially identical to the second pan 30. Like the second pan 30, the third pan 38 includes an outer rim 42 that rests upon the ridge 36 of the first pan 14, and the perimeter of the outer rim 42 is inwardly offset with respect to the outer rim 22 of the first pan when the third pan 38 is positioned in the recessed area 18. When the second pan 30 and the third pan 38 are nested within the first pan 14, the second pan 30 and the third pan 38 may substantially completely occupy the first recessed area 18. In some configurations the depth of the third pan 38 may be greater than the depth of the second pan 30, as shown, or may be substantially the same as or less than the depth of the second pan 30. Like the second pan 30, the third pan 38 is configured such that when the outer rim 42 rests upon the ridge 26, a bottom wall 44 of the third pan 38 is spaced above the bottom wall 36 of the first pan 14. In this way the third pan 38 is able to nest within the first pan 14.

The system 10 may also include at least one fourth pan 46 that differs from each of the first pan 14, second pan 30, and third pan 38, and that may be disposed within the second and third pans 30, 38. The illustrated system 10 includes one fourth pan 46, although more than one fourth pan 46 may also be provided. In the illustrated construction, the fourth pan 46 includes a substantially flat top surface 50 and a plurality (e.g., six as shown) of downwardly extending cups 54. In some configurations, the fourth pan 46 may be what is known in the art as a muffin tin. The cups 54 of the illustrated exemplary fourth pan 46 are sized and arranged to nest within the second pan 30 and the third pan 38. More specifically, two of the cups 54 are positioned and configured to nest within the third pan 38, and four of the cups 54 are positioned and configured to nest within the second pan 30. The fourth pan 46 may also independently nest directly within the first pan 14. The fourth pan 46 includes an outer rim 48 that rests upon the second pan outer rim 34 and the third pan outer rim 42. The fourth pan outer rim 48 has a perimeter that, when the fourth pan 46 is positioned on the second pan 30 and the third pan 38, is inwardly offset with respect to the outer rims 34, 42 of the second pan 30 and the third pan 38 (see FIG. 3). The fourth pan 46 is configures such that when the outer rim 48 rests upon the outer rims 34, 42 of the second and third pans 30, 38, the cups 54 are spaced above the bottom walls 35, 44 of the second and third pans 30, 38. The fourth pan 46 may have a fourth pan length that substantially corresponds to, or may be less than, the first length, but that may be greater than the first width. The fourth pan 46 may also have a fourth pan width that substantially corresponds to the first width in a manner that enables the above-described inward offset of the fourth pan outer rim 48 with respect to the outer rims 34, 42 of the second pan 30 and the third pan 38.

In various embodiments, the fourth pan 46 may be provided with more or fewer cups 54 configured and arranged such that a first plurality of the cups 54 nest within the second pan 30 and a second plurality of the cups 54 nest within the third pan 38 when the fourth pan 46 is positioned on the second pan 30 and the third pan 38. In the illustrated configuration, the first plurality of cups 54 includes a majority (e.g., four) of the cups 54 while the second plurality of cups 54 includes less than a majority (e.g., two) of the cups 54. When the system 10 includes more than one fourth pan 46, the cups 54 of the fourth pans 46 nest with one another and the lower-most fourth pan 46 nests within the second pan 30 and the third pan 38, as shown.

The system 10 may also include a fifth pan 58 that differs from each of the first, second, third, and fourth pans 14, 30, 38, 46 and that may function as a lid for the nested arrangement of bakeware. The fifth pan 58 includes a relatively shallow, rectangular body 62 that defines a second recessed area 64 (FIG. 3), and an outer rim 66 that is sized and configured to matingly engage the outer rim 22 of the first pan 14. The outer rim 66 of the fifth pan 58 includes an outer perimeter that substantially corresponds to the outer perimeter of the first pan 14. More specifically, the fifth pan 58 may have a fifth pan length that substantially corresponds to the first length, and a fifth pan width that substantially corresponds to the first width. The fifth pan 58 may be what is generally known in the art as a sheet pan. When the outer rim 66 of the fifth pan 58 is matingly engaged with the outer rim 22 of the first pan 14, the ridge 26 and those portions of the second pan 30, the third pan 38, and the fourth pan 46 that are not received within the first recessed area 18 of the first pan 14 are received by the second recessed area 64 of the fifth pan 58. In this regard, the second pan 30, the third pan 38, and the at least one fourth pan 46 are enclosed within a cavity defined by the first recessed area 18 and the second recessed area 64. As shown, a combined height of the ridge 26, the second pan outer rim 34, the third pan outer rim 42, and the fourth pan outer rim 48 (resting upon both the second pan outer rim 34 and the third pan outer rim 42) is less than a fifth pan depth of the fifth pan 58, such that the ridge 26, the second pan outer rim 34, the third pan outer rim 42, and the fourth pan outer rim 48 can fit within the second recessed area 64. At least one securement in the form of a clip 70 can be used to secure the fifth pan 58 to the first pan 14 and may be configured to clamp the outer rim 66 of the fifth pan 58 against the outer rim 22 of the first pan 14. In the illustrated configuration, the at least one clip 70 is a separate piece. In alternative embodiments, the at least one clip 70 may be moveably or fixedly coupled to, or integrally formed with one or both of the first pan 14 and the fifth pan 58.

In use, the system 10 provides a method for packaging the plurality of differently shaped bakeware items 14, 30, 38, 46, 58. The method includes disposing the second pan 30 in the recess 18 defined by the first pan 14 and disposing the third pan 38 in the recess 18 adjacent to the second pan 30. The method also includes disposing the fourth pan 46 relative to the second and third pans 30, 38, which includes disposing a first plurality of the cups 54 within the second pan 30 and a second plurality of the cups 54 within the third pan 38. The method also includes providing for mating engagement of the rim 66 of the fifth pan 58 with the rim 22 of the first pan 14 such that when the rim 66 of the fifth pan 58 is matingly engaged with the rim 22 of the first pan 14, the third pan 38, the second pan 30, and the fourth pan 46 are positioned within a cavity defined by the fifth pan 58 and the first pan 14.

The above described bakeware containers are referred to generically as pans or tins. It should be appreciated that the bakeware containers may be any type of bakeware and as such may be formed of substantially any material suitable for baking, including various metals and metal alloys, ceramics, glasses, and the like. As used herein, the terms length, width, and depth refer to the overall length, width, and depth of the bakeware items, as those terms are generally understood by those skilled in the art. More specifically, the term length refers to the distance from one end of the bakeware item to the other, and the term width refers to the distance from one side of the bakeware item to the other, with the length being greater than the width. For the exemplary square pan described above, the length and width are equal. The term depth as used herein refers to the distance between the bottom-most surface and the top surface of the respective bakeware item.

While the specific embodiments have been illustrated and described, numerous modifications come to mind without significantly departing from the spirit of the disclosure, and the scope of protection is only limited by the scope of the accompanying claims.

1. A nestable bakeware system comprising:
a first bakeware container having a first recess, the first recess being defined by a first width and a first length;
a second bakeware container disposed within the first recess, the second bakeware container being defined by a second width and a second length, wherein the second width is less than or equal to the first width, and wherein the second length is smaller than the first length; and
a third bakeware container disposed within the first recess and generally in an adjacent relationship to the second bakeware container, the third bakeware container being defined by a third width and a third length, wherein the third width is less than the first width, and wherein the third length is less than the first length and less than or equal to the second length.

2. The nestable bakeware system of claim 1, wherein the third length is substantially equal to the second width.

3. The nestable bakeware system of claim 1, wherein each of the first, second, and third bakeware containers is substantially rectangular.

4. The nestable bakeware system of claim 1, wherein a sum of the second length and the third width is substantially equal to the first length.

5. The nestable bakeware system of claim 1, wherein when the second bakeware container and the third bakeware container are disposed within the first recess, bottom walls of the second container and the third container are spaced above a bottom wall of the first container.

6. The nestable bakeware system of claim 1, wherein the second bakeware container is substantially square, and wherein the third width of the third bakeware container is less than the second width and the second length.

7. The nestable bakeware system of claim 1, wherein the first bakeware container includes a first container outer rim, the second bakeware container includes a second container outer rim, and the third bakeware container includes a third container outer rim, and wherein the second container outer rim and the third container outer rim rest upon the first container outer rim when the second bakeware container and the third bakeware container are disposed within the first recess.

8. The nestable bakeware system of claim 7, wherein the first container outer rim includes a raised ridge, and wherein the second container outer rim and the third container outer rim rest upon the raised ridge when the second bakeware container and the third bakeware container are disposed within the first recess.

9. The nestable bakeware system of claim 7, wherein the first container outer rim includes a first container perimeter, wherein the second container outer rim includes a second container perimeter, wherein the third container outer rim includes a third container perimeter, and wherein the second container perimeter and the third container perimeter are both inwardly offset with respect to the first container perimeter when the second bakeware container and the third bakeware container are disposed within the first recess.

10. The nestable bakeware system of claim 1, further comprising a lid bakeware container defining a second recess, the lid container positionable in mating engagement with the first bakeware container to enclose the second bakeware container and the third bakeware container within a cavity defined by the first recess and the second recess.

11. The nestable bakeware system of claim 10, wherein the first bakeware container includes a first container outer rim and the second bakeware container includes a second container outer rim, wherein the second container outer rim and rests upon the first container outer rim when the second bakeware container is disposed within the first recess, and wherein a height of the second container outer rim resting upon the first container outer rim is less than a depth of the lid bakeware container.

12. The nestable bakeware system of claim 10, further comprising at least one clip securing the lid bakeware container and the first bakeware container to one another.

13. The nestable bakeware system of claim 1, further comprising a fourth bakeware container having a plurality of downwardly extending cups, a first plurality of the cups being received within the second bakeware container, and a second plurality of the cups being received within the third bakeware container.

14. The nestable bakeware system of claim 13, wherein the first bakeware container includes a first container outer rim, the second bakeware container includes a second container outer rim, the third bakeware container includes a third container outer rim, and the fourth bakeware container includes a fourth container outer rim, wherein the second container outer rim and the third container outer rim rest upon the first container outer rim when the second bakeware container and the third bakeware container are disposed within the first recess, and wherein the fourth container outer rim rests upon the second container outer rim and the third container outer rim when the cups are received within the second bakeware container and the third bakeware container.

15. A method of packaging a plurality of differently shaped bakeware items, the method comprising:
disposing a second bakeware container in a recess defined by a first bakeware container, the recess having a first width and a first length, and the second bakeware container having a second width smaller than the first width and a second length smaller than the first length; and,
disposing a third bakeware container in the recess adjacent to the second bakeware container, the third bakeware container having a third width that is less than the second width, and wherein the second bakeware container and the third bakeware container substantially completely occupy the recess defined by the first bakeware container.

16. The method of claim 15, wherein disposing the second bakeware container and the third bakeware container in the recess includes spacing bottom walls of the second bakeware container and the third bakeware container above a bottom wall of the first bakeware container.

17. The method of claim 15, wherein the first bakeware container includes a first container outer rim, the second bakeware container includes a second container outer rim, and the third bakeware container includes a third container outer rim, and wherein disposing the second bakeware container and the third bakeware container in the recess includes disposing the second container outer rim and the third container outer rim upon the first container outer rim.

18. The method of claim 17, wherein the first container outer rim includes a raised ridge, and wherein disposing the second container outer rim and the third container outer rim upon the first container outer rim includes disposing the second container outer rim and the third container outer rim upon the raised ridge.

19. The method of claim 17, wherein the first container outer rim includes a first container perimeter, wherein the second container outer rim includes a second container perimeter, wherein the third container outer rim includes a third container perimeter, and wherein disposing the second bakeware container and the third bakeware container in the recess includes disposing the second container perimeter and the third container perimeter to be inwardly offset with respect to the first container perimeter.

20. The method of claim 19, further comprising disposing a fourth bakeware container having a plurality of cups relative to the second and third bakeware containers, including disposing a first plurality of the cups within the second bakeware container and a second plurality of the cups within the third bakeware container.

21. The method of claim 20, wherein the fourth bakeware container includes a fourth container outer rim having a fourth container perimeter, and wherein disposing the fourth bakeware container includes disposing the fourth container perimeter to be inwardly offset with respect to the second container perimeter and third container perimeter.

22. The method of claim 15, wherein the third bakeware container has a third length, and wherein disposing the third bakeware container in the recess includes orienting the third length to be substantially perpendicular to the first length.

23. The method of claim 15 further comprising disposing a lid bakeware container into mating engagement with the first bakeware container such that the second bakeware container and the third bakeware container are positioned within a cavity defined by the first bakeware container and the lid bakeware container.

24. The method of claim 23, further comprising securing a rim of the lid bakeware container to a rim of the first bakeware container.

25. A nestable bakeware system comprising:
a substantially rectangular first bakeware container defining a first recess and having a first container outer rim and a first container bottom wall, the first container outer rim including a first container perimeter;
a substantially square second bakeware container disposed within the first recess, the second bakeware container including a second container outer rim, a second container bottom wall, and a side length, the second container outer rim including a second container perimeter;
a substantially rectangular third bakeware container disposed within the first recess and residing adjacent to the second bakeware container, the third bakeware container including a third container outer rim, a third container bottom wall, and a third container width, the third container outer rim including a third container perimeter;
a fourth bakeware container having a plurality of downwardly extending cups, a first plurality of the cups being received within the second bakeware container, and a second plurality of the cups being received within the third bakeware container, the fourth bakeware container also including a fourth container outer rim having a fourth container perimeter;
a substantially rectangular fifth bakeware container having a fifth container outer rim and defining a second recess, the fifth container outer rim positionable in mating engagement to enclose the second bakeware container, the third bakeware container, and the fourth bakeware container within a cavity defined by the first recess and the second recess; and,
a securement securing the first container outer rim and the fifth container outer rim to one another,
wherein the third container width is less than the side length of the second bakeware container,
wherein when the second bakeware container and the third bakeware container are disposed within the first recess, the second container outer rim and the third container outer rim rest upon the first container outer rim, the second container perimeter and the third container perimeter are both inwardly offset with respect to the first container perimeter, and the second container bottom wall and the third container bottom wall are spaced above the first container bottom wall,
wherein the fourth container perimeter is inwardly offset with respect to the second container perimeter and third container perimeter when the cups of the fourth bakeware container are received within the second bakeware container and the third bakeware container, and
wherein a combined height of the fourth container outer rim resting upon the second container outer rim and the third container outer rim is less than a depth of the fifth bakeware container.

26. The nestable bakeware system of claim 25, wherein the fourth bakeware container includes six cups, and wherein four of the cups are received within the second bakeware container and two of the cups are received within the third bakeware container.

27. The nestable bakeware system of claim 25, wherein the first container outer rim includes a raised ridge, and wherein the second container outer rim and the third container outer rim rest upon the raised ridge when the second bakeware container and the third bakeware container are disposed within the first recess.

28. The nestable bakeware system of claim 25, wherein a sum of side length of the second bakeware container and a width of the third bakeware container is substantially equal to a length of the first recess.
